(19) United States
(12) Patent Application Publication
(10) Pub. No.: US 2010/0013855 A1
(43) Pub. Date: Jan. 21, 2010

(54) AUTOMATICALLY CALIBRATING PICTURE SETTINGS ON A DISPLAY IN ACCORDANCE WITH MEDIA STREAM SPECIFIC CHARACTERISTICS

(75) Inventors: CORVILLE O. ALLEN, MORRISVILLE, NC (US); ALBERT A. CHUNG, CARY, NC (US); BINH TRUONG, CARY, NC (US); KAM K. YEE, APEX, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/174,530

(22) Filed: Jul. 16, 2008

(51) Int. Cl. G09G 5/00

(52) U.S. Cl. 345/619

(57) ABSTRACT

A solution for optimizing settings of a media display device is disclosed. In the solution, a media stream can be identified. At least one stream characteristic specific to the media stream can be determined. This characteristic can be embedded in the stream itself or can be determined by analyzing the stream. At least one display device setting for playback of the media stream can be determined based at least in part upon the determined stream characteristic(s). One or more setting of the media display device can be dynamically and automatically adjusted based upon the determined display device setting(s).

### BACKGROUND OF THE INVENTION

The present invention relates to the field of media display devices, more particularly to automatically calibrating picture settings on a display in accordance with configuration data embedded in a media stream.

Over the years, display technologies have advanced significantly and newer display technologies have been created. One of the first display devices created was a cathode ray tube (CRT). Later advances introduced liquid crystal display (LCD), plasma screens, digital light project (DLP), and organic light-emitting diode (OLED) technologies. Even among a single “technology” different implementations can have significantly different optimal presentation characteristics. For example, different LCD media presenters can be configured to conform to standard presentation, for widescreen presentation, can be compliant with different HD standards, and/or can be tailored for portable media devices (a video IPOD).

In general, hardware/firmware differences in video display devices result in significant differences in optimal presentation characteristics. Because of these differences, images can look significantly different on each display type. For example, a commonly known drawback of LCD displays is how poorly they handle dark colors or “blacks.”

Further complicating matters, media presentation formats and standards are in a state of high volatility. Numerous presentation formats exist, each with its own advantages and disadvantages. Different media standards, such as, BLU-RAY, HD DVD, DVD, DIVX, MPEG4, and the like all exist for media intended to be presented upon a video display. Different media providing sources are also used to provide a video stream to a display. These media playing devices include DVR's, cable boxes, over-the-air broadcasts, video game controls, media centers, optical disk players, dock-able portable media playing devices, and the like. Each of these devices and presentation formats has vastly different optimal properties. For example, a video stream from a portable media player (e.g., video IPOD) is very different from a video stream from a DVR (i.e., often uses a highly compressed perceptual codec), that substantially different from a video stream from a cable source, etc.

Still more complications exist for optimizing a video display. Different content played from a common source often utilize different cinematographic settings, such a light level, volume level, and the like. For example, commercials are often louder and use brighter settings than syndicated shows within which they are provided. In another example, some movies are filmed to be relatively dark or utilize low light environments compared to other filmed movies. Another complication relates to a room configuration in which the video display is deployed. Room lighting, expected viewing distance, viewing angle, and the like all have a significant effect on a user's satisfaction level with a media presentation.

A traditional solution to managing these myriad of differences is to provide tools for calibrating a presentation device to show best resolution and picture quality. These tools require manual manipulation and can be very difficult for amateurs (or an average user) to utilize. Another solution is to provide various viewing modes, each having configurable factory defaults. Viewing modes can include, for example, cable TV, PC input, theater settings, HD source, and the like. All of these calibration techniques, however, at best, estimate a set of settings for a baseline situation even though (as described above) actual usage instances vary significantly from these baselines. Consequently, users of video devices rarely receive a best performance from their video display devices. This leads to a market perception of video presentation devices and components being of subjectively lower quality than is merited by objective factors of the presentation device/component.

### BRIEF DESCRIPTION OF THE SEVERAL VIEWS OF THE DRAWINGS

FIG. 1 is a schematic diagram of a system for automatically calibrating media device settings on a display in accordance with a media stream characteristic in accordance with an embodiment of the inventive arrangements disclosed herein.

FIG. 2 illustrates an example for adjusting media stream driven setting changes for a specific implementation instance in accordance with an embodiment of the inventive arrangements disclosed herein.

FIG. 3 is a flow chart of a method for automatically calibrating picture settings on a display in accordance with configuration data embedded in a media stream in accordance with an embodiment of the inventive arrangements disclosed herein.

### DETAILED DESCRIPTION OF THE INVENTION

The present invention can automatically calibrate picture settings on a video display in accordance with configuration data embedded in a media stream as the media stream is played. As the media stream is played, the present invention can read ahead in the stream to determine the content that will be played, to prepare a picture configuration to be applied. In one embodiment, the media stream can have picture configuration data embedded in the stream.

For example, a movie production company can include configuration settings in the media stream of a released movie. The embedded settings can include settings to give viewers the intended experience. For example, certain scenes of the movie can make use of high contrast colors, and other scenes can use very low contrast and dark colors. The embedded settings can include configuration settings to enhance the display of these scenes. In other embodiments, the present invention can inspect the media stream's contents to automatically determine an optimal configuration for the stream.

In one embodiment, the media stream specific settings can be determined a sufficient period in advance of video playback that display settings can be seamlessly adjusted as appropriate for playback by the time playback occurs. Media stream specific settings can cooperatively interact with other configuration settings, such as device specific settings, environmental settings, and the like to achieve optimized playback while imposing minimal demands upon an end-user.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk—read only memory (CD-ROM), compact disk—read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

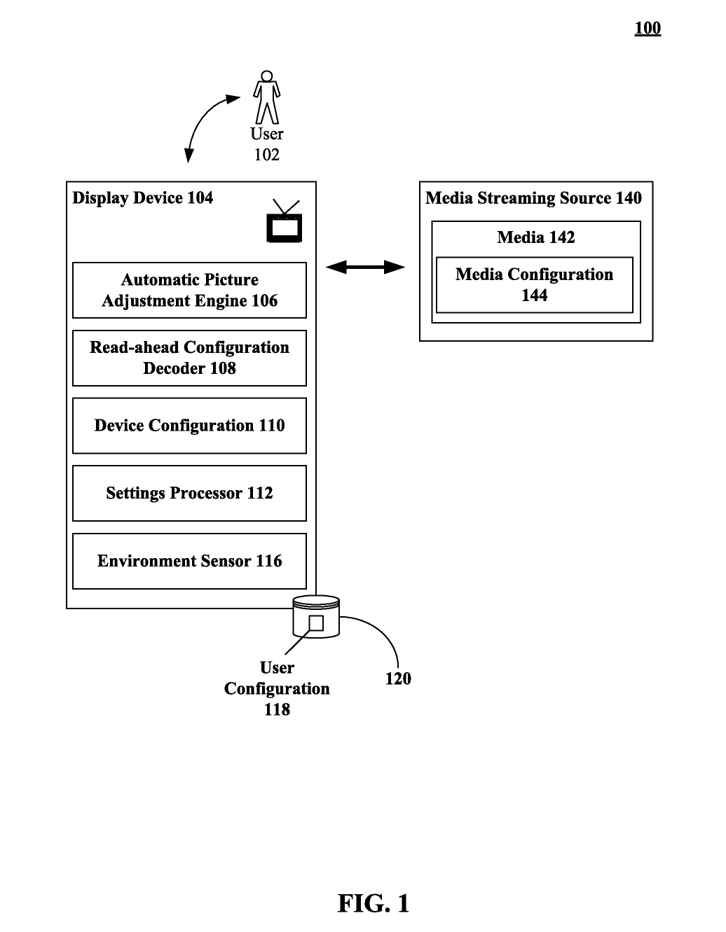

FIG. 1 is a schematic diagram of a system 100 for automatically calibrating media device settings on a display in accordance with a media stream characteristic in accordance with an embodiment of the inventive arrangements disclosed herein. System 100 can include user 102, who can interact with display device 104, which can contain components to automatically adjust its picture and/or audio settings based upon characteristics of a media stream being played. These characteristics can be digitally encoded within the media stream and/or can be automatically determined by dynamically analyzing the media stream before playback. Device 104 can include an automatic picture adjustment engine 106, read-ahead configuration decoder 108, device configuration component 110, settings processor 112, environment sensor 116, a data store 120, and/or the like.

Display device 104 can be any consumer electronic device capable of displaying a media stream, such as media 142 as provided by media streaming device 140. Display device 104 can be any kind of display device capable of automatically adjusting its picture settings, including, but not limited to, a cathode ray tube (CRT), liquid crystal display (LCD), plasma, organic light-emitting diode (OLED), and the like. The display device 104 can optionally include a tuner, an up-converter, and other optional video processing components, such as a V-Chip for parental controls. The display device 104 can be a television, a monitor, a portable media player, a video projection system, and other media presentation devices having a visual display capability.

The automatic picture adjustment engine 106 can be a software/firmware implemented engine that causes one or more setting of device 104 to be dynamically and automatically adjusted based at least in part upon a characteristic of a media stream. When stream characteristics are embedded within media streams, adjustments are made at least in part based upon these embedded characteristics. The stream characteristics can be one of many factors that result in dynamic setting adjustments being made. Other settings can include brand specific settings for device 104 (handled by device configuration component 110), environment specific settings (handled by automatically determined settings from environment sensors 116 and/or user configured environment settings 118). In one embodiment, the settings used by engine 106 can be those determined by a separate component, such as settings processor 112.

Read-ahead configuration decoder 108 of display device 104 can detect and read the data stored in media configuration 144. Read-ahead configuration decoder 108 can have the ability to read further ahead in the media stream than the playing position. In some embodiments, media configuration 144 may not be provided in the media stream. In these cases, read-ahead configuration decoder 108 can use algorithms to attempt to determine a preferred configuration according to the content being provided in the media stream. For example, read-ahead configuration decoder 108 can detect content that is darker than others and can enable a brightness adjustment to compensate for it. The read-ahead configuration decoder 108 can use any number of measurable characteristics of media 142 to determine a preferred configuration in the case that media configuration 144 is not provided.

Device configuration 110 can be a set of device-specific configuration settings. These settings can contain baseline settings for displaying the picture on display device 104. Device configuration 110 can include settings other display device types/brands wouldn't also include. For example, a cathode ray tube display may have an hourglass balance or parallelogram setting, whereas other display devices would not. Further, device specific characteristic (resolution, fidelity, max refresh rate, implementation technology, and the like) can be managed by device configuration 110. Device 104 specific settings can be maintained in data store 120 and/or within another memory space, such as a firmware chip that records the device 104 specific data.

Settings processor 112 can use reconcile various factors to determine settings that are to be applied by the adjustment engine 106. For example, the settings processor 112 can map generic settings of a media stream to device 104 specific settings. In one embodiment, the programmatic instructions of the settings processor 112 can be remotely updated, such as through a firmware update. This permits the device 104 to adapt to changes in standards of media stream encodings. For example, when a new in-stream characteristic is added, code can be added to map the new in-stream characteristic to the device 104 specific settings.

The environment sensor 116 can detect environmental characteristics of an environment in which the device 104 is positioned. For example, environment sensor 116 can detect light intensity, received sound from speakers, ambient noise, room size, and other environmental characteristics. For example, a test sound can be generated by device 104 and its echo can determine a room size. In another example, the device 104 can include a remote that enables a user to establish preferred viewing positions by making selections (detectable by the device 104) and/or calculating signal strength and direction from the remote. Any of a variety of technologies can be utilized by environment sensors 116 so long as they are capable of automatically determining an important characteristic of a viewing/user environment of the device 104.

Media streaming source 140 can be a consumer electronic device and/or a broadcast device which can provide media 142 to display device 104 for presentation. The media 142 can include video, pictures, sound, and the like. The media streaming source 140 can include, but is not limited to, a cable receiver, satellite receiver, optical media player (i.e., DVD or BLU-RAY player), a digital video recorder, a tuner, in IP television source, and the like.

The media 142 can include any of a variety of content presentable by device 104, such as video, images, and sound. The media 140 can conform to any of a number of different protocols and standards, such as BLU-RAY, MOVING PICTURES EXPERT GROUP (MPEG) 4, DIGITAL VIDEO BROADCASTING (DVB), ADVANCED TELEVISION SYSTEMS COMMITTEE (ATSC), NATIONAL TELEVISION SYSTEM COMMITTEE (NTSC), PHASE ALTERNATING LINE (PAL), VIDEO HOME SYSTEM (VHS), SUPER VHS, DIGITAL VERSATILE DISK (DVD), AUDIO VIDEO INTERLEAVE (AVI), QUICKTIME, SHOCKWAVE, REALVIDEO, DIVX, and the like.

The media configuration 144 can be a portion of the media 142 that specifies configuration specific characteristics for the stream. In one embodiment, the media configuration can be written to a standardized location of a media stream. Use of a standard for embedding media characteristics within media 142 can facilitate interoperability. The configuration 144 information can be contained in a separate segment of a storage medium and/or within a separate carrier wave from that containing the media 142. In another embodiment, a single storage medium/carrier wave can include media content 142 as well as configuration characteristics 144 for the media. The media configuration 144 information is optional and can be automatically determined by device 104 (or an intermediate analysis processor linked to device 104 that receives media 142) in one contemplated embodiment.

Data store 120 can be physically implemented within any type of hardware including, but not limited to, a magnetic disk, an optical disk, a semiconductor memory, a digitally encoded plastic memory, a holographic memory, or any other recording medium. The data store 120 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

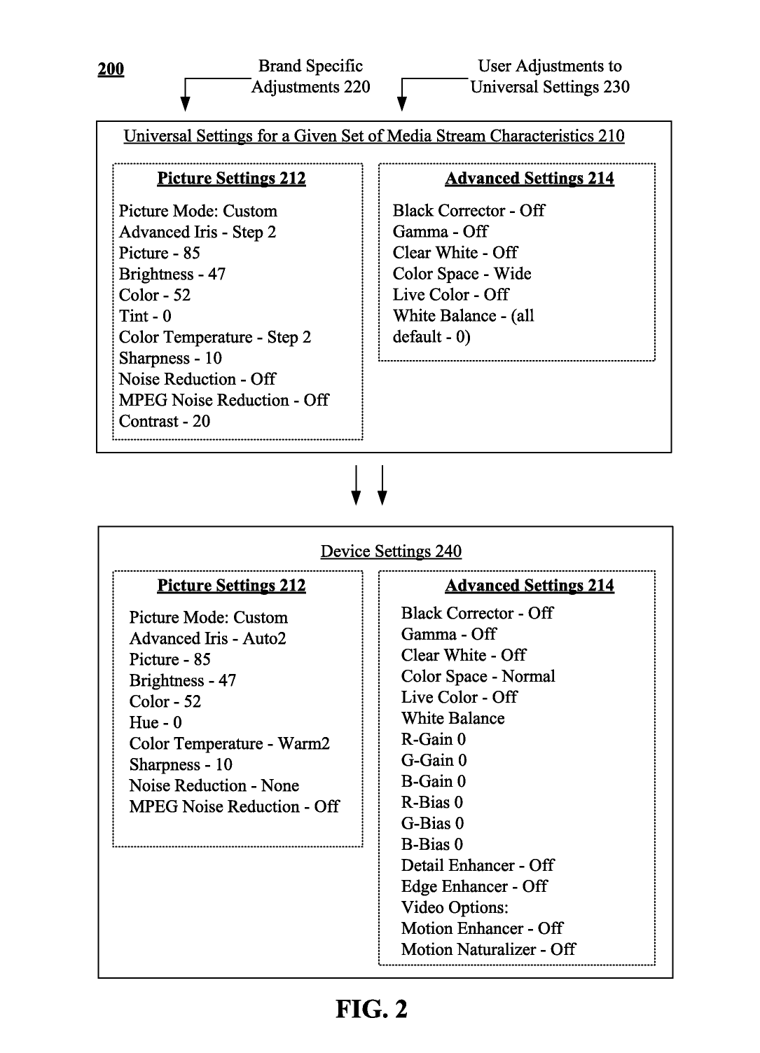

FIG. 2 illustrates an example 200 for adjusting media stream driven setting changes for a specific implementation instance in accordance with an embodiment of the inventive arrangements disclosed herein. Example 200 can be performed in context of system 100. The various settings shown in example 200 are presented for illustrated purposes only and are not to be construed as a constraint upon the scope of the present invention.

In example, 200, a set of universal settings for a given set of media stream characteristics 210 is shown. In one embodiment, this set of settings 210 can be extracted/determined directly from a media stream. In another embodiment, the set of settings 210 can result from execution of a programmatic algorithm driven by media characteristics extracted/determined from a media stream. As shown, the settings 210 can include picture settings 212 and advanced settings 214. Picture settings 212 can include picture mode, advanced iris, picture, brightness, color, tint, color temperature, sharpness, noise reduction, MPEG noise reduction, contrast, and the like. Advanced settings 214 can include black corrector, gamma, clear white, color space, live color, and white balance.

Brand specific adjustments 220, user specific adjustments 230, environmental specific adjustments, and the like can be applied to the universal settings 210 to produce device specific settings 240, which are actually applied to a specific media display device. The device settings 240 can include picture 242 and advanced settings 244, which can be mapped to the universal picture 212 and advanced settings 244. Picture settings 242 can include picture mode, advanced iris, picture, brightness, color, hue, color temperature, sharpness, noise reduction, MPEG noise reduction, and the like. Advanced settings 244 can include black corrector, gamma, clear white, color space, live color, white balance, component gain by color, and component bias by color.

Deviations from the universal 210 and device specific settings 240 are common, such as a tint of the universal settings 210 being approximately equivalent to hue of the device settings 240 to which it is mapped. Further, equivalent values for a commonly named setting between the universal setting 210 and a device setting 240 are not necessary equivalent. For example, a color value of fifty two in the universal settings 210 can be approximately equivalent to a color value of sixty in the device settings 240. Additionally, different ones of the device specific settings 240 can have a combinative effect, which means that mapping from universal settings 210 to device specific settings 240 is not always a one-to-one process, but can be a one-to-many, a many-to-one, or a many-to-many process.

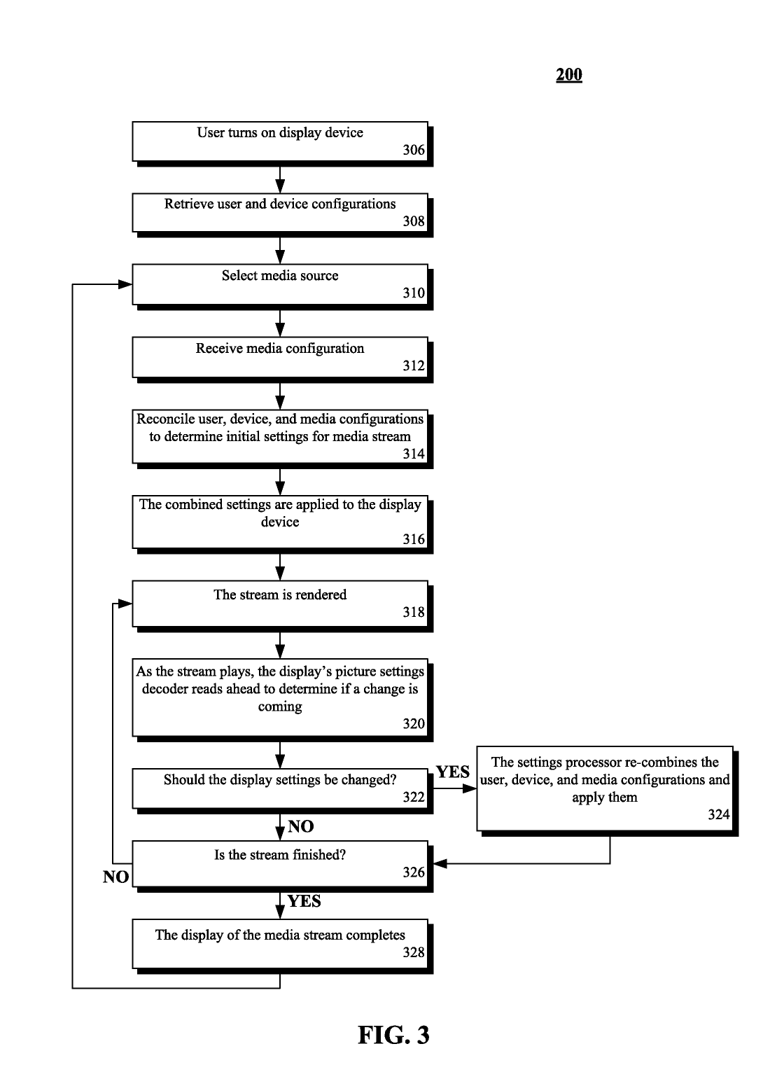

FIG. 3 is a flow chart of a method 300 for automatically calibrating picture settings on a display in accordance with configuration data embedded in a media stream in accordance with an embodiment of the inventive arrangements disclosed herein. Method 300 can be performed in context with system 100.

Method 300 can begin in step 306, where a user can turn on the display device. In step 308, the display can retrieve the device and user settings. In step 310, the user can select the media source to begin its playback. In step 312, the display device can retrieve the configuration embedded in the media. In cases where the media does not contain an embedded configuration, the display device can analyze the incoming source to try to detect a preferred configuration. In step 314, the user, device, and media configurations can be combined to determine initial settings for the media stream. Any number of factors can be used to interpret settings. For example, viewing distance, lighting amount, lighting type, age of the viewers, and the like.

In step 316, the combined settings can be applied to the display device. In step 318, the media stream can be rendered and shown on the display device. In step 320, as the stream plays, the display's picture settings decoder can read ahead in the media stream to determine if a change is coming. The picture settings decoder can detect a change in embedded configuration data, or can detect a significant visual change in the content being displayed. If in step 322, the settings should be changed, method 300 can continue to step 324, where the settings processor can recombine the user, device, and media configurations and apply them. In step 326, it can be determined if the stream has finished. If in step 322, the settings should not be changed, method 300 can continue to step 326.

If in step 326, the stream has not finished, method 300 can return to step 318, where the stream is rendered. If in step 326, the stream is finished, method 300 can continue to step 328, where the display of the media stream can complete. After step 328, method 300 can loop back to step 310, where a media source can be selected. Method 300 can loop until a user deactivates the display device.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for adjusting setting of a media display device comprising:
identifying a media stream;
determining at least one stream characteristic specific to the media stream;
automatically ascertaining at least one display device setting for playback of the media stream given the determined stream characteristic; and
dynamically adjusting a setting of the media display device to the ascertained device setting.

2. The method of claim 1, wherein said at least one media stream characteristic is digitally encoded within the identified media stream.

3. The method of claim 1, wherein the identified media stream is a unitary production that comprises a plurality of discrete scenes, wherein different ones of the discrete schemes are associated with different embedded stream characteristics, wherein the method dynamically and automatically adjusts the settings of the media display in accordance with the different embedded stream characteristics during playback of the unitary production.

4. The method of claim 1, further comprising:
identifying a format standard for encoding a media stream, wherein the format standard specifies a standard specified positioning within a media stream for encoding stream characteristics, wherein the identified media stream conforms to the standardized format.

5. The method of claim 1, further comprising:
analyzing the media stream to determine the at least one stream characteristic.

6. The method of claim 1, further comprising:
storing at least one characteristic specific to the media display device in a storage medium of the media display device; and
ascertaining the at least one display device setting based upon at least one of the stored characteristic setting and the determined stream setting.

7. The method of claim 1, further comprising:
storing at least one characteristic specific to a playback environment in a storage medium of the media display device; and
ascertaining the at least one display device setting based upon at least one of the stored characteristic setting and the determined stream setting.

8. The method of claim 1, further comprising:
storing at least one user established parameter entered through a user input interface of the media display device in a storage medium of the media display device; and
ascertaining the at least one display device setting based upon at least one of the stored user established parameter and the determined stream setting.

9. The method of claim 1, wherein the at least one setting of the media display device comprises a video presentation setting.

10. The method of claim 9, wherein the at least one setting of the media display device further comprises an audio presentation setting.

11. A computer program product for adjusting setting of a media display device comprising:
a computer usable medium having computer usable program code embodied therewith, the computer usable program code comprising:
computer usable program code configured to identify a media stream;
computer usable program code configured to determine at least one stream characteristic specific to the media stream;
computer usable program code configured to automatically ascertain at least one display device setting for playback of the media stream given the determined stream characteristic; and
computer usable program code configured to dynamically adjust a setting of the media display device to the ascertained device setting.

12. The computer program product of claim 11, wherein said at least one media stream characteristic is digitally encoded within the identified media stream.

13. The computer program product of claim 11, wherein the identified media stream is a unitary production that comprises a plurality of discrete scenes, wherein different ones of the discrete schemes are associated with different embedded stream characteristics, wherein the method dynamically and automatically adjusts the settings of the media display in accordance with the different embedded stream characteristics during playback of the unitary production.

14. The computer program product of claim 11, further comprising:
computer usable program code configured to analyze the media stream to determine the at least one stream characteristic

15. The computer program product of claim 11, further comprising:
computer usable program code configured to store at least one user established parameter entered through a user input interface of the media display device in a storage medium of the media display device; and
computer usable program code configured to ascertain the at least one display device setting based upon at least one of the stored user established parameter and the determined stream setting.

16. The computer program product of claim 11, further comprising: computer usable program code configured to store at least one characteristic specific to the media display device in a storage medium of the media display device; and
computer usable program code configured to ascertain the at least one display device setting based upon at least one of the stored characteristic setting and the determined stream setting.

17. A media display device comprising:
an automatic picture adjustment engine configured to automatically and dynamically adjust at least one display characteristic based upon at least one stream characteristic of a media stream to be presented upon a visual display.

18. The device of claim 17, further comprising:
a media stream processor configured to automatically extract at least one media characteristic digitally encoded as data that is embedded within the media stream, where the extracted media characteristic is the at least one stream characteristic.

19. The device of claim 18, further comprising:
A read-ahead decoder configured to read ahead in the media stream and to extract the at least one media characteristic far enough in advance of playback of the media stream to permit adjustments of the display characteristic indicated by the media characteristic to be automatically made before an associated portion of the media stream is presented upon the visual display.

20. The device of claim 17, wherein the video display is at least one of a television display, a computer monitor, and an embedded display of a media playing device.
